(19) United States
(12) Patent Application Publication
(10) Pub. No.: US 2007/0039308 A1
(43) Pub. Date: Feb. 22, 2007

(54) Combustion system

(76) Inventor: Toshihiro Abe, Hanamaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/574,081

(22) PCT Filed: Sep. 28, 2004
(86) PCT No.: PCT/JP04/14147

§ 371 Date: Mar. 30, 2006

(30) Foreign Application Priority Data
Oct. 1, 2003 (JP) 2003-343367

(51) Int. Cl. B64G 1/40

(52) U.S. Cl. 60/204

(57) ABSTRACT

A combustion system which comprises a combustion chamber (1) wherein the supply of air is intercepted and a fluid (L) formed by mixing combustibles with water is supplied, water in the fluid (L) is thermally decomposed, combustibles are burnt, and a gas after combustion is discharged, a fluid storage tank (40) for storing the fluid (L) formed by mixing combustibles with water, a fluid supply section (50) for supplying the fluid (L) in the fluid storage tank (40) to the combustion chamber (1), and a gas recovery section (60) for recovering a gas discharged from the combustion chamber (1). The above combustion system inhibits the formation of nitrogen oxides, since the system is almost free from the contamination of nitrogen in air, and produces an exhaust gas containing hydrogen and carbon dioxide as main components, which results in the production of a clean exhaust gas and east recovery of an exhaust gas.

### TECHNOLOGICAL FIELD

The present invention relates to a combustion system for combusting various combustible materials including waste oil, plastic, waste tires or waste organic matters such as livestock excreta and particularly to a combustion system which can completely combust the combustible materials at a high temperature by mixing it with water to form into a fluid material.

### BACKGROUND TECHNOLOGY

As a conventional combustion system for combusting a combustible material formed into a fluid state by mixing water at a high temperature, such a system disclosed in the Japanese Patent Laid-Open No. 2000-63857 (Patent Document 1) is known.

In this system, as shown in FIG. 4, a combustion chamber 100 is provided with an air nozzle 102 for ejecting a heated air heated by an air heating device 101 at a high speed and a fuel nozzle 104 through which a fluid made of a water-fossil fuel mixed emulsion can be introduced from a storage tank 103 into the air flow, the heated air heated above 1000° C. is introduced into the combustion chamber 100 for high-speed ejection, and the fluid made of the water-fossil fuel mixed emulsion is combusted by this air flow with low oxygen in the combustion chamber 100.

Patent Document 1: Japanese Patent Laid-Open No. 2000-63857

### DISCLOSURE OF THE INVENTION

Problems to be Solved by the Invention

In this conventional combustion system, a fossil fuel as a combustible material is admixed with water to be a fluid made of a water-fossil fuel mixed emulsion and water in the fluid is thermally decomposed in the combustion chamber 100 for low-oxygen combustion. But since the heated air heated by the air heating device 101 is ejected from the air nozzle 102 at a high speed, air is inevitably mixed and a nitrogen oxide is necessarily generated by nitrogen in the air and there is a problem that an exhaust gas is not favorable. Since the exhaust gas is exhausted as it is, there is an environmental problem.

The present invention was made in view of the above problems and has an object to provide a combustion system in which generation of nitrogen oxides is suppressed by preventing entry of nitrogen in an air so that the exhaust gas has hydrogen and carbon dioxide as major components and thereby the exhaust gas can be cleaner and the recovery thereof can be easier. Also, heat efficiency is improved according to need.

Means for Solving the Problems

In order to achieve the above objects, technical means of the present invention comprises a combustion chamber body to which a fluid material as a blend of a combustible material admixed with water, under interception of air supply, is introduced to cause thermal decomposition of water in said fluid material and combustion of the combustible material with discharge of the gas after combustion, and a fluid supply section for introducing the aforementioned fluid material to the aforementioned combustion chamber body.

The combustible material which can be processed by the combustion system of the present invention may be anything insofar as it can be combusted. Not only waste oil or livestock excreta which is a fluid as produced but also solid matters such as plastic scraps or waste wood may be used, for example. However, the solid matters are used after being crushed into a powdery or granulate form in advance. And the combustible material is appropriately admixed with water to be a fluid material. The amount of water can be appropriately adjusted considering heat quantity of the combustible material or the like.

According to this, in the combustion chamber body, a fluid material as a blend of a combustible material admixed with water, under interception of air supply, is introduced to cause thermal decomposition of water in the fluid material into oxygen and hydrogen and by virtue of oxygen the combustible material is substantially completely combusted and discharged out. In this case, since air supply into the combustion chamber is intercepted, nitrogen is hardly supplied so that generation of nitrogen oxides is suppressed except those caused by the combustible material. As a result, the exhaust gas can be cleaner and the recovery thereof can be easier.

And a gas recovery section for recovering a gas exhausted from the combustion chamber body is provided when necessary. Since the gas is recovered, effective use of gas is promoted.

In this case, the gas recovery section is advantageously provided with a centrifugal gas separator for separating and extracting gas by the type. Since the gas is separated and extracted by the type, more effective use of the gas can be promoted.

Also, an outer chamber body surrounding the combustion chamber body is provided according to need, a lower opening for discharging ash content in the combustion chamber body is provided at the lower part of the combustion chamber body, a discharging passage section for discharging the ash content outside the outer chamber body from the lower opening is provided, and a space between the outer chamber body and the combustion chamber body is constituted as a coolant fluid passage through which a coolant fluid for cooling the discharging passage section passes. An inlet port through which the coolant fluid flows in is provided at the lower part of the outer chamber body, and an outlet port through which the coolant fluid flows out is provided at the upper part of the outer chamber body. By this, the ash content produced in the combustion chamber falls below the combustion chamber and is discharged through the discharging passage section. In this process, the discharging passage section is cooled by the coolant fluid flowing through the coolant fluid passage. Therefore, the coolant fluid is heated by heat exchange with the discharging passage section, flown out of the outlet port and can be used as an energy source for heating, for example.

In this case, it is advantageous that a water separator is provided for separating the water content from the ash content discharged from the discharging passage section. The ash content discharged from the discharging passage section reaches the water separator, by which the ash content is separated from the water content and discharged as sludge. In this case, the amount of the sludge is extremely smaller than the fluid material to be processed so as to facilitate post-treatment thereof.

When necessary, an outer chamber body surrounding the above combustion chamber body is provided, the combustion chamber body is provided capable of rotary driving with respect to the outer chamber body, a lower opening communicating into the combustion chamber body for introducing a fluid material is provided at the lower part of the combustion chamber body, and an upper opening communicating into the combustion chamber body for exhausting an exhaust is provided at the upper part of the combustion chamber body. And the combustion chamber body comprises an outer cylinder and an inner cylinder, in which the inner cylinder of the combustion chamber body is constituted of a heat-resistant fluid pressed against the outer cylinder by the centrifugal force of the combustion chamber body to form the inner wall of the combustion chamber body.

In this case, it is advantageous that the heat-resistant fluid forming the inner cylinder of the combustion chamber body is constituted of a ceramic melted by combustion of the combustible material in the combustion chamber body and pressed against the outer cylinder by the centrifugal force.

According to this, in the combustion chamber body, the heat-resistant fluid forms the inner cylinder under the centrifugal force by high-speed rotation of the combustion chamber body, and infrared rays are reflected on the inner surface of the cylinder of this molten heat-resistant fluid to an extremely high temperature. Therefore, an ascending swirl is generated in the combustion chamber body, the inside of the combustion chamber body is brought into a high temperature and high pressure, and the combustible material is surely substantially completely burnt off by the oxygen obtained by thermally decomposed water in the fluid material.

Moreover, when necessary, an ignition device may be provided for igniting the combustible material introduced into the combustion chamber body to facilitate start of the device.

Furthermore, when necessary, the ignition device is constituted of a high-frequency heater body provided in the combustion chamber body. High temperature is surely ensured and the device can be started easily.

Furthermore, when necessary, a fluid storage tank is provided for storing a fluid material as a blend of the combustible material admixed with water. Since the fluid material is stored, water content adjustment or the like can be facilitated.

In this case, it is advantageous that a water supply section for introducing water into the fluid storage tank is provided and a mixer for agitating the fluid material in the fluid storage tank is provided in the fluid storage tank. The fluid storage tank is charged with the fluid material which is adjusted to have appropriate water content with the water from the water supply section with agitation with the mixer. By virtue thereof, homogenization is accomplished and combustion in the combustion chamber can be carried out smoothly.

Moreover, when necessary, the fluid supply section may be provided with a transient tower through which the fluid material produced in the fluid storage tank passes, a high-pressure pump provided at the lower part of the transient tower for forcibly feeding the fluid material to the upper part of the transient tower, and an ejector body connected to the upper part of the transient tower through a junction pipe for ejecting the fluid material forcibly fed into the combustion chamber body into the combustion chamber body. The fluid material can be surely ejected from the ejector body.

In this case, it is advantageous that a magnetic field generator attached to the junction pipe for applying a magnetic field to the fluid material flowing through the junction pipe is provided. Negative ions are produced from the fluid material to facilitate combustion thereof.

Furthermore, when necessary, an exhaust pipe through which a gas exhausted from an upper opening provided at the upper part of the combustion chamber body passes is provided, and the exhaust pipe is provided with a spiral pipe disposed in the transient tower from the upper part thereof to the lower part thereof for cross heat exchange between the gas in the exhaust pipe and the fluid material in the transient tower. The exhaust passes through the spiral pipe of the exhaust pipe, where cross heat exchange is carried out between the gas in the exhaust pipe and the fluid material in the transient tower, and the fluid material is heated and ejected from the ejector body. Accordingly, good heat efficiency can be obtained and the reliability of combustion can be increased so much.

Moreover, when necessary, the exhaust pipe on the downstream side of the spiral pipe is disposed so that it passes through the fluid storage tank. By this, too, the fluid material is heated and ejected from the ejector body. Accordingly, good heat efficiency can be obtained and the reliability of combustion can be increased so much.

Furthermore, an exhaust pipe through which a gas exhausted from the upper opening provided at the upper part of the combustion chamber body passes is provided and a power turbine is provided in a passage of the exhaust pipe. Since the power turbine is driven by the exhaust, it is used for power generation or the like and effective use of energy is promoted.

Furthermore, when necessary, an oxygen supplier for supplying oxygen into the combustion chamber body is provided. By operating the oxygen supplier at an appropriate moment, ignition can be ensured and combustion can be stabilized.

Furthermore, when necessary, a hydrogen supplier for supplying hydrogen into the combustion chamber body is provided. By operating the hydrogen supplier at an appropriate moment, ignition can be ensured and combustion can be stabilized.

Furthermore, when necessary, a neutralizer injector for filling a neutralizer for gases other than oxygen, hydrogen and carbon dioxide is provided in the combustion chamber body. By this neutralizer, the gases other than oxygen, hydrogen and carbon dioxide can be neutralized to some extent and discharged as ash content, which further facilitates taking out of oxygen, hydrogen and carbon dioxide.

Advantage of the Invention

According to the combustion system of the present invention, in the combustion chamber body, under interception of air supply, a fluid material as a blend of a combustible material admixed with water is introduced to cause thermal decomposition of water in the fluid material into oxygen and hydrogen and by virtue of oxygen the combustible material is substantially completely combusted, while nitrogen is hardly supplied so that generation of nitrogen oxides can be suppressed. As a result, the exhaust gas can be cleaner and the recovery thereof can be easier.

And if a gas recovery section for recovering the gas exhausted from the combustion chamber body is provided, since the gas is recovered, effective use of gas can be promoted. In this case, if the gas recovery section comprises a centrifugal gas separator for separating and extracting the gas by the type, since the gas is separated and extracted by the type, further effective use of gas can be promoted and other effects are exerted.

### BRIEF DESCRIPTION OF DRAWING

FIG. 1 is a sectional view showing a combustion system according to a first embodiment of the present invention;

FIG. 2 is a sectional view showing a combustion system according to a second embodiment of the present invention;

FIG. 3 is a sectional view showing a combustion system according to a third embodiment of the present invention; and

FIG. 4 is a sectional view showing an example of a conventional combustion system.

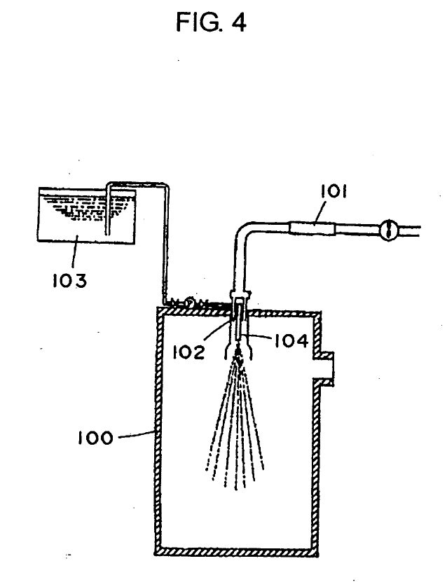

### DESCRIPTION OF SYMBOLS

L Fluid material
1 Combustion chamber body
2 Inner cylinder
3 Outer cylinder
4 Lower opening
5 Upper opening
6 Outer chamber body
8 Discharging passage section
9 Coolant fluid passage
10 Inlet port
11 Outlet port
12 Water separator
14 Oxygen supplier
15 Oxygen ejection pipe
20 Neutralizer injector
23 Magnetic field generator
30 Ignition device
31 High-frequency heater body
40 Fluid storage tank
41 Opening
42 Water supply section
43 Mixer
50 Fluid supply section
51 Transient tower
52 High-pressure pump
53 Junction pipe
54 Ejector body
55 Magnetic field generator
56 Exhaust pipe
56a Spiral pipe
57 Water discharge section
58 Power turbine
60 Gas recovery section
61 Centrifugal gas separator
62 Hydrogen taking-out pipe line
63 Carbon dioxide taking-out pipe line
64 Other gases taking-out pipe line
70 Cylindrical body
71 Exhaust port
72 Intermediate partition wall
74 Exhaust space
75 Storage section
76 Rotation driving section
78 Glass
80 Outer cylinder
81 Inner cylinder
83 Hydrogen supplier
84 Hydrogen ejection pipe
85 Cylindrical body
88 Rotation driving section
90 Fluid supply section
91 Suction pump
92 Temporary fluid storage tank
93 Ejector body
94 Junction pipe
110 Coolant fluid supply device
111 High-pressure pump
112 Coolant temporary fluid storage tank
113 Inflow pipe
116 Ejection orifice
120 Heating tank
121 Inlet port
122 Outlet port
130 Exhaust pipe
130a a Spiral pipe
130b Spiral-formed pipe
131, 135 Detour pipe

### BEST MODE FOR CARRYING OUT INVENTION

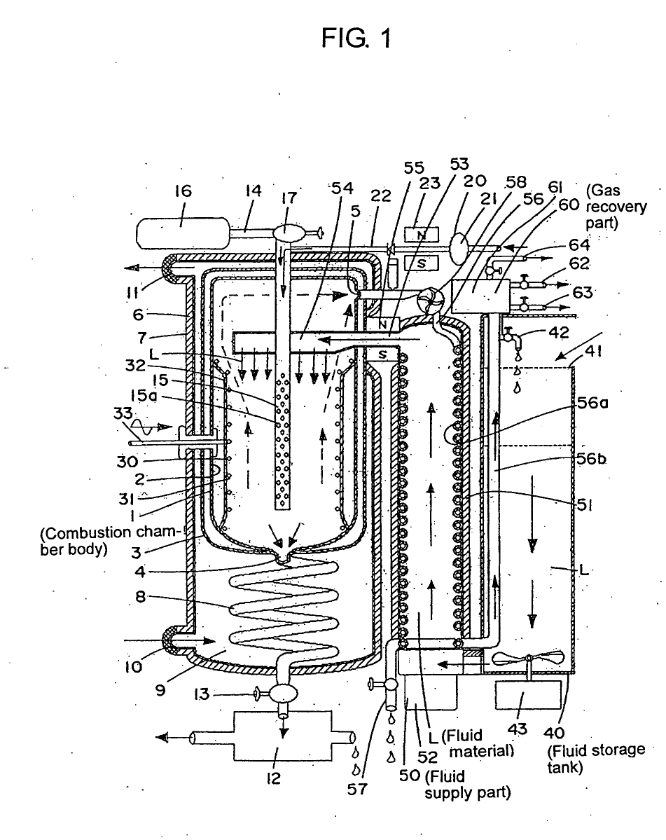

A combustion system according to an embodiment of the present invention will be described in detail based on the attached drawings. FIG. 1 shows a combustion system according to a first embodiment of the present invention.

In the embodiment, a combustible material to be processed is a fluid material such as a waste oil or livestock excreta, for example.

As shown in FIG. 1, a basic construction of the combustion system according to the embodiment comprises a combustion chamber body 1 to which a fluid material L as a blend of a combustible material admixed with water is introduced to cause thermal decomposition of water in this fluid material L, a fluid storage tank 40 for storing the fluid material L as a blend of the combustible material admixed with water, a fluid supply section 50 for introducing the fluid material L in the fluid storage tank 40 to the combustion chamber body 1, and a gas recovery section 60 for recovering gas exhausted from the combustion chamber body 1.

The combustion chamber body 1 is so constituted that, under interception of air supply, the fluid material L as a blend of the combustible material admixed with water is introduced to cause thermal decomposition of water in the fluid material L and combustion of the combustible material with discharge of the gas after combustion. In more detail, the combustion chamber body 1 is constituted by an inner cylinder 2 in the form of a capsule shaped of a metal having high melting point such as tungsten (with the melting point of 3407° C.) and an outer cylinder 3 in the form of a capsule shaped of a metal such as a stainless steel and covering the inner cylinder 2 with a space between them. The space between the inner cylinder 2 and the outer cylinder 3 performs insulating action. At the lower part of the combustion chamber body 1, a lower opening 4 for discharging an ash content in the combustion chamber body 1 is formed, and at the upper part, an upper opening 5 for exhausting the gas after combustion is formed. A temperature in the combustion chamber body 1 reaches 1000 to 3000° C., for example, at combustion. By this, water is thermally decomposed to oxygen and hydrogen.

The combustion chamber body 1 is surrounded and supported by an outer chamber body 6 surrounding it. The outer chamber body 6 is shaped of a metal such as, for example, a stainless steel in the form of a capsule and the outer surface is coated with an insulating material 7. At the lower opening 4 provided at the lower part of the combustion chamber body 1 for discharging the ash content of the combustion chamber body 1, an discharging passage section 8 in the form of a spiral pipe is provided for discharging the ash content to the outside of the outer chamber body 6 from the lower opening 4. And the space between the outer chamber body 6 and the combustion chamber body 1 is constituted as a coolant fluid passage 9 through which a coolant fluid for cooling the discharging passage section 8 (cooling water in the embodiment) is passed. At the lower part of the outer chamber body 6, an inlet port 10 through which the coolant fluid flows in is provided, while at the upper part of the outer chamber body 6, an outlet port 11 through which the coolant fluid flows out is provided. This coolant fluid is heated by heat exchange with the discharging passage section 8, flows out as a hot water or steam from the outlet port 11 and used as an energy source for heater, for example.

On the outside of the outer chamber body 6, a water separator 12 for separating the water content from the ash content discharged from the discharging passage section 8 by centrifugal separation, for example, is provided. Reference numeral 13 is a valve provided at the discharging passage section 8.

Moreover, in this system, an oxygen supplier 14 for supplying oxygen into the combustion chamber body 1 is provided. The oxygen supplier 14 is provided with an oxygen ejection pipe 15 having a large number of ejection orifices 15a and suspended in the combustion chamber body 1 from above for ejecting oxygen so as to supply oxygen from an oxygen cylinder 16 into the combustion chamber body 1. Reference numeral 17 is a regulating valve for regulating a supply amount of oxygen. This oxygen supplier 14 is operated at the start of the system or at an appropriate moment for stabilizing thermal power, for example.

Moreover, in this system, a neutralizer injector 20 for filing a neutralizer for a gas other than oxygen, hydrogen and carbon dioxide is provided in the combustion chamber body 1. The neutralizer injector 20 is to fill the neutralizer into the oxygen ejection pipe 15 from a gear pump 21 from a neutralizer storage tank, not shown, through a filling pipe 22 so that the neutralizer is sprayed into the combustion chamber body 1 from the ejection orifices 15a of the oxygen ejection pipe 15. In the filling pipe 22, a magnetic field generator 23 is attached for applying a magnetic field to the fluid material L flowing through the filling pipe 22. By this, negative ions are produced from the neutralizer to improve to improve the function of the neutralizer.

Moreover, in the embodiment, an ignition device 30 for igniting the combustible material supplied into the combustion chamber body 1 is provided. The ignition device 30 is constituted by a high-frequency heater body 31 provided in the combustion chamber body 1. The high-frequency heater body 31, for example, is made of a high-frequency electromagnetic induction coil and attached to an inner wall of the inner cylinder 2 of the combustion chamber body 1 through an insulator 32. Reference numeral 33 is a power supply section of the high-frequency heater body 31. This ignition device 30 is operated at the start of the system or at an appropriate moment for stabilizing thermal power.

A fluid storage tank 40 has an opening 41 through which the fluid material L as a blend of the combustible material admixed with water is introduced and stores the introduced fluid material L. Reference numeral 42 is a water supply section for supplying water into the fluid storage tank 40. An adequate amount of water is supplied from this water supply section 42 and a water amount of the fluid material L is adjusted to adequate. Also, in the fluid storage tank 40, a mixer 43 for agitating the fluid material L in the fluid storage tank 40 is provided.

A fluid supply section 50 is constituted by a transient tower 51 through which the fluid material L produced in the fluid storage tank 40 passes, a high-pressure pump 52 provided at the lower part of the transient tower 51 for forcibly feeding the fluid material L to the upper part of the transient tower 51, and an ejector body 54 connected at the upper part of the transient tower 51 through a junction pipe 53 for ejecting the fluid material L forcibly fed into the combustion chamber body 1 into the combustion chamber body 1. The ejector body 54 is provided at the upper part of the combustion chamber body 1 for spraying the fluid material L into the combustion chamber body 1 in the shower state.

Moreover, to the junction pipe 53, a magnetic field generator 55 for applying a magnetic field to the fluid material L flowing through the junction pipe 53 is attached. By this, negative ions are produced from the fluid material L to facilitate combustion thereof.

Furthermore, in this system, an exhaust pipe 56 through which a gas exhausted from the upper opening 5 provided at the upper part of the combustion chamber body 1 is passed is provided. The exhaust pipe 56 is disposed in the transient tower 51 from the upper part thereof to the lower part thereof and is provided with a spiral pipe 56a performing cross heat exchange between the gas in the exhaust pipe 56 and the fluid material L in the transient tower 51.

Also, an exhaust pipe 56 (56b) on the downstream side of the spiral pipe 56a is disposed so that it passes through the fluid storage tank 40. A steam exhausted to the exhaust pipe 56 is cooled and discharged from a water discharge section 57 or supplied from a gas recovery section 60, which will be described later, as water of the water supply section 42 for use.

Furthermore, a power turbine 58 is provided in a path of the exhaust pipe 56 to the transient tower 51 and is used for power generation or the like.

The gas recovery section 60 is to recover the gas exhausted from the combustion chamber body 1, and it is connected to the exhaust pipe 56 passing through the fluid storage tank 40 and provided with a centrifugal gas separator 61 for separating and extracting the gas by the type. In the embodiment, the gas is separated to hydrogen, carbon dioxide and other gases and recovered. The centrifugal gas separator 61 is provided with a hydrogen taking-out pipe line 62, a carbon dioxide taking-out pipe line 63 and an other-gases taking-out pipe line 64.

Therefore, in the combustion system according to this embodiment, the fluid storage tank 40 is charged with the fluid material L which is adjusted to have appropriate water content with the water from the water supply section 42 along with agitation with the mixer 43. B y virtue thereof, homogenization is accomplished leading to smoothness of combustion described later in the combustion chamber body 1.

At the start of this system, the ignition device 30 is operated, that is, the high-frequency heater body 31 is operated, and the temperature of the combustion chamber body 1 is raised to a high temperature. At this time, oxygen is supplied from the oxygen supplier 14. When the high-pressure pump 52 of the fluid supply section 50 is operated in this state, the fluid material L stored in the fluid storage tank 40 passes through the transient tower 51 and is sprayed into the combustion chamber body 1 from the ejector body 54. By this, water in the fluid material L is thermally decomposed to oxygen and hydrogen and the combustible material begins to be combusted by this oxygen and the oxygen supplied from the oxygen supplier 14. And when the combustion is brought into a stationary state, the ignition device 30 and the oxygen supplier 14 are stopped. The ignition device 30 and the oxygen supplier 14 can be operated at an appropriate moment for stabilization of combustion.

In the stationary state, the combustible material is substantially completely combusted by the oxygen obtained from thermal decomposition of water in the fluid material L. In the combustion chamber body 1, hydrogen, carbon dioxide, steam, excessive oxygen and other gases are generated and exhausted from the exhaust pipe 56. And by the exhaust, the power turbine 58 is driven and offered for use in power generation or the like. Also, the exhaust passes through the spiral pipe 56a of the exhaust pipe 56, where cross heat exchange is performed between the gas in the exhaust pipe 56 and the fluid material L in the transient tower 51. Therefore, since the fluid material L is heated and ejected from the ejector body 54, good heat efficiency can be obtained and the reliability of combustion can be increased so much. Also, since the exhaust pipe 56 on the downstream side of the spiral pipe 56a passes through the fluid storage tank 40, the fluid material L is also heated by this and ejected from the ejector body 54. Accordingly, good heat efficiency can be obtained and the reliability of combustion can be increased so much.

On the other hand, the gas is cooled and reaches the gas recovery section 60 and the gas is separated by the centrifugal gas separator 61 of the gas recovery section 60 to hydrogen, carbon dioxide and other gases and recovered. In this case, since supply of air to the combustion chamber body 1 is intercepted, nitrogen is hardly supplied and generation of nitrogen oxides except those caused by the combustible material is suppressed. As a result, the exhaust gas can be cleaner and the recovery thereof can be easier.

Also, the ash content produced in the combustion chamber body 1 falls below the combustion chamber body 1 and is discharged from the discharging passage section 8. In this process, the discharging passage section 8 is cooled by the coolant fluid flowing through the coolant fluid passage 9. Therefore, the coolant fluid is heated by heat exchange with the discharging passage section 8 to become a hot water or steam and flows out of the outlet port 11 and used as an energy source for heating, for example.

The ash content discharged from the discharging passage section 8 reaches the water separator 12, where the ash content is separated from the water content and discharged as sludge. In this case, the amount of the sludge is extremely small as compared with the fluid material L to be processed so as to facilitate post-treatment thereof.

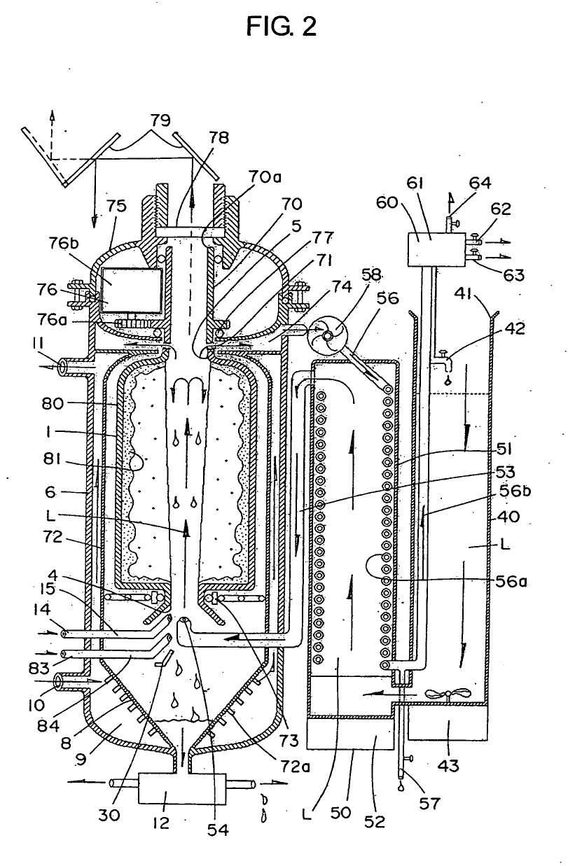

In FIG. 2, the combustion system according to a second embodiment of the present invention is shown. This is different from that in the first embodiment in the structure of the combustion chamber body 1. The same components as the first embodiment are given the same reference numerals for explanation.

In the combustion system according to the second embodiment, the combustion chamber body 1 is shaped in the form of a capsule, the lower opening 4 communicating into the combustion chamber body 1 for introducing the fluid material L is provided at the lower part of the combustion chamber body 1, and the upper opening 5 communicating to the combustion chamber body 1 for exhausting the exhaust is provided at the upper part of the combustion chamber body 1. A cylindrical body 70 is provided adjoiningly to the upper opening 5. And an exhaust port 71 communicating to the upper opening 5 is formed at the base end of the cylindrical body 70.

Moreover, in this system, the outer chamber body 6 in the form of a capsule surrounding the combustion chamber body 1 is provided, and the combustion chamber body 1 is provided capable of rotation and driving through an intermediate partition wall 72 with respect to the outer chamber body 6. Reference numeral 73 is a bearing rotatably supporting the lower part of the combustion chamber body 1 with respect to the intermediate partition wall 72. Reference numeral 74 is an exhaust space formed at the upper part of the outer chamber body 6 for introducing an exhaust from the exhaust port 71 to the exhaust pipe 56, which will be described later.

Also, on the upper side of the outer chamber body 6, a storage section 75 for storing the cylindrical body 70 is provided, and at this storage section 75, a rotation driving section 76 comprised by a gear device 76a for rotationally driving the cylindrical body 70 to rotate the combustion chamber body 1 and a motor 76b is provided. Reference numeral 77 is a bearing for rotatably supporting the cylindrical body 70 with respect to the storage section 75.

Also, on a ceiling of the storage section 75, a transparent glass 78 opposed to an opening 70a of the cylindrical body 70 is provided so that a light generated in the combustion chamber body 1 can be taken out. The light is taken out from the glass 78 through a mirror 79 or an optical fiber, for example, to be used as laser beam.

Moreover, the combustion chamber body 1 comprises an outer cylinder 80 and an inner cylinder 81, and the inner cylinder 81 of the combustion chamber body 1 is constituted of a heat-resistant fluid forming the inner wall of the combustion chamber body 1 as being pressed against the outer cylinder 80 by the centrifugal force of the combustion chamber body 1. The heat-resistant fluid forming the inner cylinder 81 of the combustion chamber body 1 is constituted of a ceramic melted by combustion of the combustible material in the combustion chamber body 1 and pressed against the outer cylinder 80 side by the centrifugal force.

In more detail, the outer cylinder 80 is formed of tungsten (with the melting point of 3407° C.) and the inner cylinder 81 is formed of a ceramic, for example, sakurundum (with the melting point of 2432° C.). Here, the ceramic forming the inner cylinder 81 is melted by combustion of the combustible material, pressed against the outer cylinder 80 by the centrifugal force and forms the combustion chamber body 1. Melting of the ceramic insulates high temperature by combustion and makes it difficult to transmit the temperature to the outer cylinder 80, which improves heat resistance of the combustion chamber body 1. The ceramic is introduced from the cylindrical body 70 before the operation of the combustion system as particles and melted during the operation of the combustion system so as to form the inner cylinder 81.

Furthermore, at the lower part of the intermediate partition wall 72, the discharging passage section 8 in the funnel shape for discharging the ash content discharged out of the lower opening 4 of the combustion chamber body 1 to the outside of the outer chamber body 6 is provided. And a space between the outer chamber body 6 and the intermediate partition wall 72 is comprised as a coolant fluid passage 9 through which the coolant fluid (cooling water in the embodiment) for cooling the discharging passage section 8 flows. Reference numeral 72a is a cooling fin provided outside the discharging passage section 8. At the lower part of the outer chamber body 6, the inlet port 10 through which the coolant fluid flows in is provided, while at the upper part of the outer chamber body 6, the outlet port 11 through which the coolant fluid flows out is provided. This coolant fluid is heated by heat exchange with the discharging passage section 8 to be a hot water or steam, flown out from the outlet port 11 and used as an energy source for heating, for example.

On the outside of the outer chamber body 6, the water separator 12 for separating the water content from the ash content discharged out of the discharging passage section 8 by centrifugal force, for example, is provided.

And in this system, the oxygen supplier 14 for supplying oxygen into the combustion chamber body 1 is provided. The oxygen supplier 14 is provided with the oxygen ejection pipe 15 for ejecting oxygen from the lower opening 4 of the combustion chamber body 1. Also, the hydrogen supplier 83 for supplying hydrogen into the combustion chamber body 1 is provided. The hydrogen supplier 83 is provided with a hydrogen ejection pipe 84 for ejecting hydrogen from the lower opening 4 of the combustion chamber body 1. The oxygen supplier 14 and the hydrogen supplier 83 are operated at the start of this system or at an appropriate moment for stabilizing thermal power, for example.

And in the embodiment, the ignition device 30 for igniting the combustible material supplied to the combustion chamber body 1 is provided. The ignition device 30 is constituted of an ignition plug in the vicinity of lower opening 4 of the combustion chamber body 1.

The fluid storage tank 40 has the opening 41 through which the fluid material L as a blend of a combustible material admixed with water is introduced and stores the introduced fluid material L. Reference numeral 42 denotes a water supply section for supplying water into the fluid storage tank 40. From this water supply section 42, an adequate amount of water is supplied to adjust a water amount of the fluid material L to adequate. Also, the fluid storage tank 40 is provided with the mixer 43 for agitating the fluid material L in the fluid storage tank 40.

A fluid supply section 50 is constituted by the transient tower 51 through which the fluid material L produced in the fluid storage tank 40 passes, the high-pressure pump 52 connected at the lower part of the transient tower 51 for forcibly feeding the fluid material L to the upper part of the transient tower 51, and the ejector body 54 provided at the upper part of the transient tower 51 through the junction pipe 53 for ejecting the fluid material L forcibly fed into the combustion chamber body 1 into the combustion chamber body 1. The ejector body 54 is constituted of a nozzle for spraying the fluid material L toward the lower opening 4 of the combustion chamber body 1.

Moreover, in this system, the exhaust pipe 56 connected to the exhaust space 74 provided at the upper part of the outer chamber body 6 is provided, through which the gas to be exhausted from the exhaust port 71 is passed. The exhaust pipe 56 is disposed in the transient tower 51 from the upper part to the lower part and provided with the spiral pipe 56a for performing cross heat exchange between the gas in the exhaust pipe 56 and the fluid material L in the transient tower 51.

Moreover, the exhaust pipe 56 (56b) on the downstream side of the spiral pipe 56a is disposed to pass through the fluid storage tank 40. The steam exhausted to the exhaust pipe 56 is cooled and discharged from the water discharge section 57, or is used as water of the water supply section 42 supplied from the gas recovery section 60, which will be described later.

Furthermore, the power turbine 58 is provided in the path of the exhaust pipe 56 to the transient tower 51 and offered for use in power generation or the like.

The gas recovery section 60 is to recover gas exhausted from the combustion chamber body 1, connected to the exhaust pipe 56 passing through the fluid storage tank 40 and provided with the centrifugal gas separator 61 for separating and extracting the gas by the type. In the embodiment, gas is separated to hydrogen, carbon dioxide and other gases and recovered. The centrifugal gas separator 61 is provided with the hydrogen taking-out pipe line 62, the carbon dioxide taking-out pipe line 63 and the other-gases taking-out pipe line 64.

Therefore, in the combustion system according to this embodiment, the fluid storage tank 40 is charged with the fluid material L which is adjusted to have appropriate water content with the water from the water supply section 42 along with agitation with the mixer 43. By virtue thereof, homogenization is accomplished leading to smoothness of combustion described later in the combustion chamber body 1.

And at the start of the system, the combustion chamber body 1 is rotated by the rotation driving section 76, and oxygen and hydrogen are supplied from the oxygen supplier 14 and the hydrogen supplier 83 into the combustion chamber body 1. In this state, the ignition plug of the ignition device 30 is operated, and the temperature of the combustion chamber body 1 is raised to a high temperature by combustion of hydrogen by oxygen. And when ceramic particles are introduced from the cylindrical body 70, the ceramics is melted by combustion of hydrogen and pressed onto the outer cylinder 80 side by the centrifugal force so as to form the inner cylinder 81.

When the high-pressure pump 52 of the fluid supply section 50 is operated in this state, the fluid material L stored in the fluid storage tank 40 is ejected from the ejector body 54 through the transient tower 51 into the combustion chamber body 1. By this, the water in the fluid material L is thermally decomposed to oxygen and hydrogen, and the combustible material begins to be combusted by this oxygen and the oxygen supplied from the oxygen supplier 14. And when the combustion is brought into a stationary state, the oxygen supplier 14 and the hydrogen supplier 83 are stopped. It is to be noted that the ignition device 30, the oxygen supplier 14 and the hydrogen supplier 83 can be operated at an appropriate moment for stabilization of combustion.

In the stationary state, in the combustion chamber 1, an ascending swirl is generated, the inside of the combustion chamber body 1 is brought into a high temperature and high pressure, and the combustible material is substantially completely burnt off by the oxygen obtained from thermally decomposed water in the fluid material L. That is, at this time, in the combustion chamber body 1, the molten ceramic is brought closer to upright in the form of a cylindrical wall under the centrifugal force by high-speed rotation of the combustion chamber body 1, and infrared rays are reflected on the inner surface of the cylinder of this molten ceramic. Then, the infrared rays encounter more difficulty in going out of the exhaust port 71 and the temperature is further increased resulting in substantially complete combustion. In the combustion chamber body 1, hydrogen, carbon dioxide, steam, and other gases such as excessive oxygen are generated and discharged from the exhaust pipe 56. And by the exhaust, the power turbine 58 is driven and offered for use in power generation or the like. The exhaust gas passes through the spiral pipe 56a of the exhaust pipe 56, where cross heat exchange is performed between the gas in the exhaust pipe 56 and the fluid material L in the transient tower 51.

Therefore, since the fluid material L is heated and ejected from the ejector body 54, good heat efficiency can be obtained and the reliability of combustion can be increased so much.

On the other hand, the gas is cooled and reaches the gas recovery section 60. And it is separated by the centrifugal gas separator 61 of the gas recovery section 60 to hydrogen, carbon dioxide and other gases and recovered. In this case, since supply of air into the combustion chamber body 1 is intercepted, nitrogen is hardly supplied and thus, generation of nitrogen oxides is suppressed except those caused by the combustible material. As a result, the exhaust gas can be cleaner and the recovery thereof can be easier.

Also, the ash content produced in the combustion chamber body 1 falls below the combustion chamber body 1 and is discharged out of the discharging passage section 8. In this process, the discharging passage section 8 is cooled by the coolant fluid flowing through the coolant fluid passage 9. Therefore, the coolant fluid is heated by heat exchange with the discharging passage section 8 to become a hot water or steam and flows out of the outlet port 11 and used as an energy source for heating, for example.

The ash content discharged out of the discharging passage section 8 reaches the water separator 12, where the ash content is separated from the water content and discharged as sludge. In this case, the amount of the sludge is extremely small as compared with the fluid material L to be processed so as to facilitate post-treatment thereof.

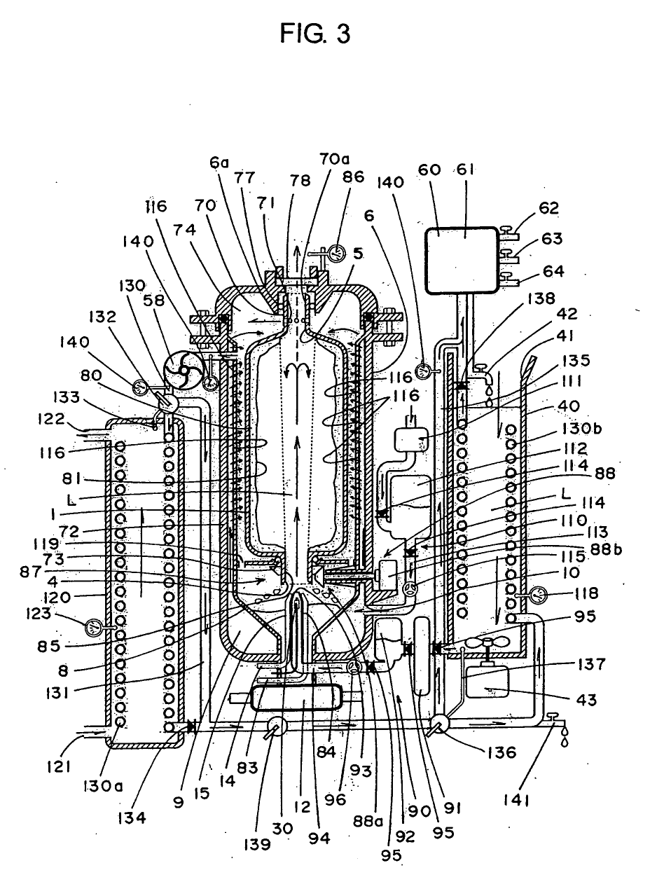

FIG. 3 shows a combustion system according to a third embodiment of the present invention. This is similar to the second embodiment in principle, but the structure of the outer chamber body, the fluid supply section, the coolant fluid passage, etc. is different. It is to be noted that the same components as those in the second embodiment are given the same reference numerals for explanation.

In the combustion system according to the third embodiment, the combustion chamber body 1 is formed in the form of a capsule, the lower opening 4 communicating into the combustion chamber body 1 for introducing the fluid material L is provided at the lower part of the combustion chamber body 1, and the upper opening 5 communicating to the combustion chamber body 1 for exhausting the exhaust is provided at the upper part of the combustion chamber body 1. The cylindrical body 70 is provided adjoiningly to the upper opening 5. Also, a cylindrical body 85 is provided adjoiningly to the lower opening 6. And the exhaust port 71 communicating to the upper opening 5 is formed at the base end of the cylindrical body 70.

Also, in this system, the outer chamber body 6 in the form of a capsule surrounding the combustion chamber body 1 is provided, and the combustion chamber body 1 is provided capable of rotary drive through the intermediate partition wall 72 with respect to the outer chamber body 6. Reference numeral 74 denotes an exhaust space formed at the upper part of the outer chamber body 6 for introducing the exhaust from the exhaust port 71 to the exhaust pipe 130, which will be described later.

Moreover, on the lower side of the outer chamber body 6, a storage section 87 faced by the cylindrical body 85 is provided. Furthermore, on the lower side of the outer chamber body 6, a rotation driving section 88 for rotating the combustion chamber body 1 is provided. The rotation driving section 88 comprises a gear device 88a provided at the storage section 87 for rotating the combustion chamber body 1 by rotationally driving the cylindrical body 85 and a motor 88b provided outside the outer chamber body 6 and connected to the gear device 88a. Reference numeral 73 denotes a bearing rotatably supporting the cylindrical body 85 of the combustion chamber body 1 with respect to the intermediate partition wall 72. Reference numeral 77 is a bearing for rotatably supporting the cylindrical body 70 on the outer chamber body.

Also, the transparent glass 78 opposed to the opening 70a of the cylindrical body 70 is provided on the ceiling 6a of the outer chamber body 6 so that a light generated inside the combustion chamber body 1 can be taken out. The light is taken out from the glass 78 through the mirror or an optical fiber as in the second embodiment, for example, to be used as laser beam.

Reference numeral 86 in the figure denotes a temperature sensor for measuring the temperature of the light having passed the glass 78.

Furthermore, the combustion chamber body 1 comprises the outer cylinder 80 and the inner cylinder 81, and the inner cylinder 81 of the combustion chamber body 1 is constituted of a heat-resistant fluid forming the inner wall of the combustion chamber body 1 as being pressed against the outer cylinder 80 by the centrifugal force of the combustion chamber body 1. The heat-resistant fluid forming the inner cylinder 81 of the combustion chamber body 1 is constituted of a ceramic melted by combustion of the combustible material in the combustion chamber body 1 and pressed against the outer cylinder 80 side by the centrifugal force.

In more detail, the outer cylinder 80 is formed of tungsten (with the melting point of 3407° C.) and the inner cylinder 81 is formed of a ceramic, for example, sakurundum (with the melting point of 2432° C.). Here, the ceramic forming the inner cylinder 81 is melted by combustion of the combustible material, pressed against the outer cylinder 80 by the centrifugal force and forms the combustion chamber body 1. Melting of the ceramic insulates high temperature by combustion and makes it difficult to transmit the temperature to the outer cylinder 80, which improves heat resistance of the combustion chamber body 1. The ceramic is introduced from the cylindrical body 70 before the operation of the combustion system as particles and melted during the operation of the combustion system so as to form the inner cylinder 81. The temperature inside the combustion chamber body 1 reaches 1,000 to 70,000° C., for example, at combustion. By this, water is thermally decomposed to oxygen and hydrogen.

Furthermore, the discharging passage section 8 in the form of a funnel for discharging the ash content discharged out of the lower opening 4 of the combustion chamber body 1 to the outside of the outer chamber body 6 is provided at the lower part of the intermediate partition wall 72. And a space between the outer chamber body 6 and the intermediate partition wall 72 is constituted as the coolant fluid passage 9 through which the coolant fluid for cooling the discharging passage section 8 (cooling water in the embodiment) is passed. At the lower part of the outer chamber body 6, the inlet port 10 through which the coolant fluid flows in is provided. At the inlet port 10, a coolant fluid supply device 110 for supplying the coolant fluid is provided. The coolant fluid supply device 110 is provided with a high-pressure pump 111 for sucking the coolant fluid, a coolant temporary fluid storage tank 112 for temporarily storing the coolant fluid from the high-pressure pump 111, and an inflow pipe 113 for connecting the coolant temporary fluid storage tank 112 and inlet port 10. The high-pressure pump 111 sucks water from a tank storing the coolant fluid, for example. In the figure, reference numeral 114 denotes a check valve for preventing backflow of the coolant fluid, and reference numeral 115 denotes a flow-rate regulating valve for regulating a flow rate of the coolant fluid flowing into the coolant fluid passage 9.

Moreover, at the intermediate partition wall 72, a plurality of ejection orifices 116 from which the coolant fluid flowing through the coolant fluid passage 9 is ejected are provided. The coolant fluid ejected from the ejection orifices 116 is sprayed toward the combustion chamber body 1, cools the outer cylinder 3 of the combustion chamber body 1 and flows down outside the outer cylinder 3 and then, passes holes 119 provided on the outside of the bearing 73 and is discharged out of the discharging passage section 8 to the outside of the outer chamber body 6 with the ash content. And this coolant fluid is separated by a centrifugal force by the water separator 12 and taken out. This water separator 12 is provided outside of the outer chamber body 6 for separating the water content from the ash content discharged out of the discharging passage section 8 by centrifugal separation, for example.

Moreover, in this system, the oxygen supplier 14 for supplying oxygen into the combustion chamber body 1 is provided. The oxygen supplier 14 is provided with the oxygen ejection pipe 15 for ejecting oxygen from the lower opening 4 of the combustion chamber body 1. Also, the hydrogen supplier 83 for supplying hydrogen into the combustion chamber body 1 is provided. The hydrogen supplier 83 is provided with the hydrogen ejection pipe 84 for ejecting hydrogen from the lower opening 4 of the combustion chamber body 1. The oxygen supplier 14 and the hydrogen supplier 83 are operated at the start of this system or at an appropriate moment for stabilizing thermal power, for example.

Also, in this embodiment, the ignition device 30 for igniting the combustible material supplied to the combustion chamber body 1 is provided. The ignition device 30 is constituted by the ignition plug provided in the vicinity of the lower opening 4 of the combustion chamber body 1.

The fluid storage tank 40 has the opening 41 through which the fluid material L as a blend of a combustible material admixed with water is introduced and stores the introduced fluid material L. Reference numeral 42 denotes the water supply section for supplying water into the fluid storage tank 40. From this water supply section 42, an adequate amount of water is supplied to adjust a water amount of the fluid material L to adequate. Also, the fluid storage tank 40 is provided with the mixer 43 for agitating the fluid material L in the fluid storage tank 40. In the figure, reference numeral 118 denotes a temperature sensor for measuring the temperature of the fluid material L in the fluid storage tank 40.

The fluid supply section 90 comprises a suction pump 91 for sucking the fluid material L at the lower part of the fluid storage tank 40, a temporary fluid storage tank 92 for temporarily storing the fluid material L sucked by this suction pump 91, and an ejection body 93 for ejecting the fluid material L stored in the temporary fluid storage tank 92 into the combustion chamber body 1 through a junction pipe 94. In the figure, reference numeral 95 denotes a check valve for preventing backflow of the fluid material L and reference numeral 96 denotes a flow-rate regulating valve for regulating a flow rate of the fluid material L to be ejected into the combustion chamber body 1.

Moreover, in this combustion system, a heating tank 120 is provided into which a fluid from another system or the like (water for heated pool, for example) is drawn for cross heat exchange between this fluid and a gas in an exhaust pipe 130, which will be described later. At the lower part of the heating tank 120 is provided an inlet port 121 through which the fluid flows in, and at the upper part thereof is provided an outlet port 122 through which the fluid flows out. In the figure, reference numeral 123 denotes a temperature sensor for measuring the temperature of the fluid in the heating tank 120.

Furthermore, in this system, the exhaust pipe 130 connected to the exhaust space 74 provided at the upper part of the outer chamber body 6 and through which the gas exhausted from the exhaust port 71 is passed is provided. The exhaust pipe 130 comprises a spiral pipe 130a disposed from the upper part to the lower part of the heating tank 120, and a spiral-formed pipe 130b disposed within the fluid storage tank 40 from the lower part to the upper part. The spiral pipe 130a is for cross heat exchange between the gas in the exhaust pipe 130 and the fluid in the heating tank. Also, the spiral-formed pipe 130b is provided on the downstream side of the spiral pipe 130a disposed inside the heating tank 120 for cross heat exchange between the gas in the exhaust pipe 130 and the fluid material L in the fluid storage tank 40.

Furthermore, the exhaust pipe 130 is provided with a detour pipe 131 branching on the upstream side from the spiral pipe 130a and merging on the downstream side of the spiral pipe 130a. At the branching point of the detour pipe 131 and the spiral pipe 130a is provided an electromagnetic valve 132 for selectively having gas to communicate to the spiral pipe 130a and the detour pipe 131. The electromagnetic valve 132 regulates an amount of gas flowing into the spiral pipe 130a based on a temperature detection sensor 133 for detecting a temperature of the fluid inside the heating tank 120. Also, at the spiral pipe 130a on the upstream side from the merging point of the detour pipe 131 and the spiral pipe 130a, a check valve 134 for preventing backflow from the detour pipe 131 side is provided.

Furthermore, the exhaust pipe 130 is provided with a detour pipe 135 on the downstream side of the spiral pipe 131, branching on the upstream side from the spiral-formed pipe 130b and merging on the downstream side of the spiral-formed pipe 130b. At the branching point of the detour pipe 135 and the spiral-formed pipe 130b, an electromagnetic valve 136 for selectively having the gas to communicate to the spiral-formed pipe 130b and the detour pipe 135 is provided. The electromagnetic valve 136 regulates an amount of gas flowing into the spiral-formed pipe 130b based on a temperature detection sensor 137 for detecting a temperature of the fluid in the fluid storage tank 40. Also, at the spiral-formed pipe 130b on the upstream side from the merging point of the detour pipe 135 and the spiral-formed pipe 130b is provided a check valve 138 for preventing backflow from the detour pipe 135 side.

Also, in the path of the exhaust pipe 130 between the spiral pipe 130a and the spiral-formed pipe 130b, an electromagnetic regulating valve 139 for regulating a flow rate of the gas flowing inside is provided. In the figure, reference numeral 140 is a pressure sensor for measuring the pressure of the gas inside the exhaust pipe 130. Reference numeral 141 is a drain for draining water provided in the path of the exhaust pipe 130.

Moreover, the power turbine 58 is provided in the path of the exhaust pipe 130 to the heating tank 120 and offered for use in power generation or the like.

The gas recovery section 60 is to recover gas exhausted from the combustion chamber body 1, connected to the exhaust pipe 130 passing through the fluid storage tank 40 and provided with the centrifugal gas separator 61 for separating and extracting the gas by the type. In the embodiment, gas is separated to hydrogen, carbon dioxide and other gases and recovered. The centrifugal gas separator 61 is provided with the hydrogen taking-out pipe line 62, the carbon dioxide taking-out pipe line 63 and the other-gases taking-out pipe line 64.

Therefore, in the combustion system according to this embodiment, the fluid storage tank 40 is charged with the fluid material L which is adjusted to have appropriate water content with the water from the water supply section 42 along with agitation with the mixer 43. By virtue thereof, homogenization is accomplished leading to smoothness of combustion described later in the combustion chamber body 1.

And at the start of the system, the combustion chamber body 1 is rotated by the rotation driving section 88, and oxygen and hydrogen are supplied from the oxygen supplier 14 and the hydrogen supplier 83 into the combustion chamber body 1. In this state, the ignition plug of the ignition device 30 is operated, and the temperature of the combustion chamber body 1 is raised to a high temperature by combustion of hydrogen by oxygen. And when ceramic particles are introduced from the cylindrical body 70, the ceramic is melted by combustion of hydrogen and pressed against the outer cylinder 3 by the centrifugal force so as to form the inner cylinder 2.

When the suction pump 91 of the fluid supply section 90 is operated in this state, the fluid material L stored in the fluid storage tank 40 is sucked and reserved in the temporary fluid storage tank 92 and ejected from the temporary fluid storage tank 92 into the combustion chamber body 1 through the ejection body 93. By this, the water in the fluid material L is thermally decomposed to oxygen and hydrogen, and the combustible material begins to be combusted by this oxygen and oxygen supplied from the oxygen supplier 14. And when the combustion is brought into a stationary state, the oxygen supplier 14 and the hydrogen supplier 83 are stopped. It is to be noted that the ignition device 30, the oxygen supplier 14 and the hydrogen supplier 83 can be operated at an appropriate moment for stabilization of combustion.

In the stationary state, in the combustion chamber 1, an ascending swirl is generated, the inside of the combustion chamber body 1 is brought into a high temperature and high pressure, and the combustible material is substantially completely burnt off by the oxygen obtained from thermally decomposed water in the fluid material L. That is, at this time, in the combustion chamber body 1, the molten ceramic is brought closer to upright in the form of a cylindrical wall under the centrifugal force by high-speed rotation of the combustion chamber body 1, and infrared rays are reflected on the inner surface of the cylinder of this molten ceramic. Then, the infrared rays encounter more difficulty in going out of the exhaust port and the temperature is further increased resulting in substantially complete combustion. In the combustion chamber body 1, hydrogen, carbon dioxide, steam, and other gases such as excessive oxygen are generated and discharged from the exhaust pipe 130. And by the exhaust, the power turbine 58 is driven and offered for use in power generation or the like. The exhaust passes through the spiral pipe 130a of the exhaust pipe 130, where cross heat exchange is performed between the gas in the exhaust pipe 130 and the fluid material L in the heating tank 120. Also, the fluid material L in the fluid storage tank 40 is heated in the exhaust pipe 130 in the downstream from the heating tank 120. Therefore, since the fluid material L is heated and ejected from the ejector body 93, good heat efficiency can be obtained and the reliability of combustion can be increased so much.

Also, even if the temperature of the outer cylinder 3 becomes high due to combustion in the combustion chamber body 1, the coolant fluid is ejected to the outer cylinder 3 of the combustion chamber body 1 and cools the outer cylinder 3. Therefore, melting of the outer cylinder 3 can be prevented.

On the other hand, the gas is cooled and reaches the gas recovery section 60. And it is separated by the centrifugal gas separator 61 of the gas recovery section 60 to hydrogen, carbon dioxide and other gases and recovered. In this case, since supply of air into the combustion chamber body 1 is shut down, nitrogen is hardly supplied and thus, generation of nitrogen oxides is suppressed except those caused by the combustible material. As a result, the exhaust gas can be cleaner and the recovery thereof can be easier.

Also, the ash content produced in the combustion chamber body 1 falls below the combustion chamber body 1 and is discharged out of the discharging passage section 8. In this process, the discharging passage section 8 is cooled by the coolant fluid flowing through the coolant fluid passage 9.

The ash content discharged out of the discharging passage section 8 reaches the water separator 12, where the ash content is separated from the water content and discharged as sludge. In this case, the amount of the sludge is extremely small as compared with the fluid material L to be processed so as to facilitate post-treatment thereof.

While in the second and the third embodiments, the ignition device 30 is constituted of the ignition plug, it is not necessarily limited to this and the ignition device 30 can be constituted of the high-frequency heater body 31 in the first embodiment and change can be made appropriately.

Also, in the second and the third embodiments, a transparent glass is provided oppositely to the opening of the cylindrical body 70, but another glass may be provided above this glass and these two glasses may be so constituted that they can be opened/closed alternately and a waste such as bulk refuse is temporarily stored in a space between the two glasses and introduced into the combustion chamber body, and appropriate change can be made.

### INDUSTRIAL APPLICABILITY

In the present invention, a waste organic matter can be substantially completely burnt so that an exhaust gas from the combustion system can be cleaner, and hydrogen and carbon dioxide can be recovered to be reused. Therefore, contribution can be made to effective use of various wastes.

1. A combustion system comprising a combustion chamber body to which a fluid material as a blend of a combustible material admixed with water, under interception of air supply, is introduced to cause thermal decomposition of water in said fluid material and combustion of the combustible material with discharge of the gas after combustion, and a fluid supply section for introducing the aforementioned fluid material to the aforementioned combustion chamber body.

2. The combustion system according to claim 1, wherein a gas recovery section for recovering the gas exhausted from said combustion chamber body is provided.

3. The combustion system according to claim 2, wherein said gas recovery section is provided with a centrifugal gas separator for separating and extracting gas by the type.

4. The combustion system according to claim 1, wherein an outer chamber body surrounding said combustion chamber body is provided, a lower opening for discharging an ash content in the combustion chamber body is provided at the lower part of said combustion chamber body, a discharging passage section for discharging the ash content from the lower opening to the outside of said outer chamber body is provided, a space between said outer chamber body and the combustion chamber body is constituted as a coolant fluid passage through which a coolant fluid passes to cool said discharging passage section, an inlet port through which the coolant fluid flows in is provided at the lower part of the outer chamber body, and an outlet port through which the coolant fluid flows out is provided at the upper part of the outer chamber body.

5. The combustion system according to claim 4, wherein a water separator for separating the water content from the ash content discharged from said discharging passage section is provided.

6. The combustion system according to claim 1, characterized by: providing an outer chamber body surrounding the aforementioned combustion chamber body in such a fashion that the aforementioned combustion chamber body can be driven to rotate against the aforementioned outer chamber body; providing a lower opening which intercommunicates with the inside of said combustion chamber body for introducing the fluid material, to the lower part of the aforementioned combustion chamber body; providing an upper opening which intercommunicates with the aforementioned combustion chamber body for exhausting the exhaust, to the upper part of the aforementioned combustion chamber body; constituting the aforementioned combustion chamber body of an outer cylinder and an inner cylinder; and constituting the inner cylinder of the aforementioned combustion chamber body of a heat-resistant fluid forming the inner wall of the combustion chamber body as being pressed against the outer cylinder by the centrifugal force of the aforementioned combustion chamber body.

7. The combustion system according to claim 6, wherein the heat-resistant fluid forming the inner cylinder of said combustion chamber body is constituted of ceramic melted by combustion of the combustible material in the combustion chamber body and pressed against the outer cylinder by the centrifugal force.

8. The combustion system according to claim 1, wherein an ignition device for igniting the combustible material supplied to said combustion chamber body is provided.

9. The combustion system according to claim 8, wherein said ignition device is constituted of a high-frequency heater body provided in said combustion chamber body.

10. The combustion system according to claim 1, wherein a fluid storage tank for storing the fluid material as a blend of said combustible material admixed with water is provided.

11. The combustion system according to claim 10, wherein a water supply section for supplying water into said fluid storage tank is provided and a mixer for agitating the fluid material in the fluid storage tank is provided in the fluid storage tank.

12. The combustion system according to claim 1, wherein said fluid supply section is provided with a transient tower through which said fluid material passes, a high-pressure pump provided at the lower part of the transient tower for forcibly feeding said fluid material to the upper part of the transient tower, and an ejection body connected to the upper part of said transient tower through a junction pipe for ejecting the fluid material forcibly fed into said combustion chamber body into the combustion chamber body.

13. The combustion system according to claim 12, wherein a magnetic field generator attached to said junction pipe for applying a magnetic field to the fluid material flowing through the junction pipe is provided.

14. The combustion system according to claim 12, wherein an exhaust pipe through which a gas exhausted from the upper opening provided at the upper part of said combustion chamber body passes is provided, and the exhaust pipe is provided with a spiral pipe disposed in said transient tower from the upper part thereof to the lower part thereof for performing cross heat exchange between the gas in the exhaust pipe and the fluid material in the transient tower.

15. The combustion system according to claim 14, wherein a fluid storage tank for storing the fluid material as a blend of said combustible material admixed with water is provided, and the exhaust pipe on the downstream side of said spiral pipe is disposed so that it passes through said fluid storage tank.

16. The combustion system according to claim 1, wherein an exhaust pipe through which a gas exhausted from the upper opening provided at the upper part of said combustion chamber body passes is provided, and a power turbine is provided in a path of the exhaust pipe.

17. The combustion system according to claim 1, wherein an oxygen supplier for supplying oxygen into said combustion chamber body is provided.

18. The combustion system according to claim 1, wherein a hydrogen supplier for supplying hydrogen into said combustion chamber body is provided.

19. The combustion system according to claim 1, wherein a neutralizer injector for filling a neutralizer for gasses other than oxygen, hydrogen and carbon dioxide is provided in said combustion chamber body.
